(19) United States
(12) Patent Application Publication
(10) Pub. No.: US 2008/0190454 A1
(43) Pub. Date: Aug. 14, 2008

(54) SUBSTRATE TREATMENT METHOD AND SUBSTRATE TREATMENT APPARATUS

(76) Inventor: Atsuro Eitoku, Kyoto (JP)

Correspondence Address: OSTROLENK FABER GERB & SOFFEN, 1180 AVENUE OF THE AMERICAS, NEW YORK, NY, 100368403, US

(21) Appl. No.: 12/028,406

(22) Filed: Feb. 8, 2008

(30) Foreign Application Priority Data
Feb. 9, 2007 (JP) 2007-031245

(51) Int. Cl. B08B 3/04

(52) U.S. Cl. 134/19; 134/57 R; 134/30

(57) ABSTRACT

The inventive substrate treatment method includes a treatment liquid supplying step, a pre-drying liquid supplying step and a vapor supplying step. In the treatment liquid supplying step, a treatment liquid is supplied to a major surface of a substrate. In the pre-drying liquid supplying step, a first lower surface-tension liquid having a lower surface tension than deionized water is supplied to the major surface after the treatment liquid supplying step. In the vapor supplying step, vapor of a second lower surface-tension liquid having a lower surface tension than the deionized water and soluble in the first lower surface-tension liquid is supplied to the major surface after the pre-drying liquid supplying step.

### BACKGROUND OF THE INVENTION

1. Field of the Invention

The present invention relates to a substrate treatment method and a substrate treatment apparatus. Exemplary substrates to be treated include semiconductor wafers, substrates for liquid crystal display devices, substrates for plasma display devices, substrates for FED (Field Emission Display) devices, substrates for optical disks, substrates for magnetic disks, substrates for magneto-optical disks, substrates for photo masks and ceramic substrates.

2. Description of Related Art

In production processes for semiconductor devices and liquid crystal display devices, a substrate such as a semiconductor wafer or a liquid crystal display glass substrate is generally treated with a treatment liquid. More specifically, a chemical agent treatment process is performed to treat a major surface of the substrate with a chemical agent supplied to the major surface, and then a rinsing process is performed to rinse away the chemical agent from the substrate by supplying deionized water to the major surface of the substrate supplied with the chemical agent.

After the rinsing process, a drying process is performed to dry the substrate by removing the deionized water remaining on the substrate. An exemplary method of performing the drying process is such that the deionized water present on the substrate is replaced with liquid IPA (isopropyl alcohol) which is an organic solvent more volatile than the deionized water by supplying the IPA to the major surface of the substrate after the rinsing process, and then the substrate is dried by removing the IPA from the substrate. See, for example, JP-A-2003-92280.

However, the aforementioned method for the drying process requires much time for completely replacing the deionized water with the IPA on the substrate. That is, when the liquid IPA is supplied to the major surface of the substrate after the rinsing process, the deionized water present on the substrate is mostly replaced with the IPA in a short period of time, but part of the deionized water intruding into inner portions of a pattern formed on the substrate cannot be readily replaced. Therefore, the liquid IPA should be supplied for a longer period of time for the complete replacement of the deionized water with the IPA on the substrate. Accordingly, the consumption of the IPA is increased. Since an organic solvent such as IPA is expensive, it is desirable to reduce the consumption.

It is also conceivable to supply IPA vapor instead of the liquid IPA to the major surface of the substrate after the rinsing process. However, when the IPA vapor is supplied to the substrate, the vapor is properly supplied to a part of the substrate located adjacent a vapor outlet port, but it is difficult to properly supply the vapor to a part of the substrate located apart from the vapor outlet port. Therefore, the amount of the IPA dissolved in the deionized water on the substrate varies depending on a position on the substrate, thereby resulting in an uneven IPA concentration on the substrate.

If the uneven IPA concentration occurs on the substrate, the surface tension of a liquid mass present on the substrate varies and, therefore, convection is liable to occur in the liquid mass due to the Marangoni effect. A surface portion of the substrate on which the deionized water is not sufficiently replaced with the IPA is liable to be exposed from the liquid mass by the convection, resulting in collapse of the pattern, formation of water marks and other defects which may be caused by the surface tension of the water-containing liquid mass remaining in the minute pattern.

### SUMMARY OF THE INVENTION

It is an object of the present invention to provide a substrate treatment method and a substrate treatment apparatus which permit reduction in process time while suppressing damages and defects which may result from improper drying.

It is another object of the present invention to provide a substrate treatment method and a substrate treatment apparatus which permit reduction in the consumption of treatment fluids to be employed for improving a substrate drying efficiency.

A substrate treatment method according to the present invention comprises a treatment liquid supplying step, a pre-drying liquid supplying step and a vapor supplying step. In the treatment liquid supplying step, a treatment liquid is supplied to a major surface of a substrate. In the pre-drying liquid supplying step, a first lower surface-tension liquid having a lower surface tension than pure water or deionized water is supplied to the major surface after the treatment liquid supplying step. In the vapor supplying step, vapor of a second lower surface-tension liquid having a lower surface tension than the deionized water and soluble in the first lower surface-tension liquid is supplied to the major surface after the pre-drying liquid supplying step.

According to the present invention, the treatment liquid is supplied to the major surface of the substrate (in the treatment liquid supplying step), and then the first lower surface-tension liquid which is lower in surface tension than the deionized water is supplied to the major surface (in the pre-drying liquid supplying step). Thus, most of the treatment liquid is rinsed away from the substrate, and the substrate surface is covered with the first lower surface-tension liquid.

After the first lower surface-tension liquid is supplied to the major surface of the substrate, the vapor of the second lower surface-tension liquid which is lower in surface tension than the deionized water and soluble in the first lower surface-tension liquid and slightly different in surface tension from the first lower surface-tension liquid is supplied to the major surface of the substrate covered with the first lower surface-tension liquid (in the vapor supplying step). This makes it possible to dissolve the second lower surface-tension liquid in a liquid mass present on the substrate while preventing the substrate surface from being exposed from the liquid mass due to the Marangoni convection.

More specifically, the second lower surface-tension liquid is soluble in the first lower surface-tension liquid, so that the vapor of the second lower surface-tension liquid supplied to the substrate is condensed (liquefied) on the surface of the liquid mass containing the first lower surface-tension liquid on the substrate and then dissolved in the liquid mass. Since most of the liquid mass present on the substrate is the first lower surface-tension liquid, the surface tension of the liquid mass on the substrate is substantially equal to the surface tension of the first lower surface-tension liquid. Therefore, when the vapor of the second lower surface-tension liquid, which is lower in surface tension than the deionized water similarly to the first lower surface-tension liquid, is supplied to the major surface of the substrate, the convection attributable to the Marangoni effect is suppressed, and the second lower surface-tension liquid is dissolved in the liquid mass on the substrate. Thus, a liquid phase containing the second lower surface-tension liquid is formed on the substrate.

When the vapor of the second lower surface-tension liquid is supplied onto the substrate, the vapor of the second lower surface-tension liquid is dissolved in the liquid mass present on the substrate. Thus, the vapor concentration of the treatment liquid present above the substrate is reduced. This promotes evaporation of the remaining treatment liquid from the surface of the liquid mass on the substrate, making it possible to completely remove the treatment liquid from the substrate. This suppresses collapse of a pattern and other damages occurring due to the surface tension of the treatment liquid, and water marks and other defects resulting from improper drying.

In the pre-drying liquid supplying step, the treatment liquid is not entirely replaced with the first lower surface-tension liquid, but most of the treatment liquid is replaced with the first lower surface-tension liquid. Therefore, the period of the supply of the first lower surface-tension liquid can be reduced. This reduces the overall substrate treatment period. Further, the consumption of the first lower surface-tension liquid can be reduced correspondingly to the reduction in the period of the supply of the first lower surface-tension liquid.

Usable as the treatment liquid are, for example, a chemical agent, a rinse liquid and the like. Usable as the first lower surface-tension liquid and the second lower surface-tension liquid are, for example, organic solvents which are lower in surface tension than the deionized water. The first lower surface-tension liquid may be soluble or insoluble in the treatment liquid. Further, the first lower surface-tension liquid and the second lower surface-tension liquid may be of different types or of the same type.

The second lower surface-tension liquid to be supplied in a vapor form to the major surface of the substrate in the vapor supplying step is soluble in the treatment liquid.

In this case, a trace amount of the treatment liquid contained in the liquid mass present on the substrate can be dissolved in the second lower surface-tension liquid dissolved in the liquid mass on the substrate in the vapor supplying step. This makes it possible to diffuse the treatment liquid into the liquid mass present on the substrate and evaporate the treatment liquid from the surface of the liquid mass. Thus, the treatment liquid remaining on the major surface of the substrate subjected to the pre-drying liquid supplying step can be efficiently removed from the major surface.

The second lower surface-tension liquid soluble in the treatment liquid may be a single-component liquid soluble in the treatment liquid or a liquid mixture containing a liquid soluble in the treatment liquid.

The first lower surface-tension liquid to be supplied to the major surface of the substrate in the pre-drying liquid supplying step may be lower in surface tension than the treatment liquid supplied to the major surface of the substrate in the treatment liquid supplying step. The second lower surface-tension liquid to be supplied in the vapor form to the major surface of the substrate in the vapor supplying step may be lower in surface tension than the treatment liquid supplied to the major surface of the substrate in the treatment liquid supplying step.

In this case, the first and second lower surface-tension liquids are lower in surface tension than the treatment liquid. Therefore, the surface tension of the liquid mass covering the major surface of the substrate is reduced by supplying the first lower surface-tension liquid and the vapor of the second lower surface-tension liquid to the major surface of the substrate. That is, the surface tension of the liquid mass covering the major surface of the substrate is reduced as compared with a case in which the major surface of the substrate is covered with the treatment liquid. With the surface tension thus reduced, the treatment liquid can be removed from the substrate.

Further, the convection occurring due to the Marangoni effect can be suppressed by first supplying the first lower surface-tension liquid to the major surface of the substrate and then supplying the vapor of the second lower surface-tension liquid to the major surface of the substrate. In addition, the treatment liquid is not evaporated from the major surface of the substrate but from the surface of the liquid mass present on the substrate. This makes it possible to completely remove the treatment liquid from the substrate while suppressing the defects resulting from improper drying.

The second lower surface-tension liquid to be supplied in the vapor form to the major surface of the substrate in the vapor supplying step is different in surface tension from the first lower surface-tension liquid by not greater than a predetermined value.

In this case, a difference in surface tension between the first lower surface-tension liquid and the second lower surface-tension liquid is not greater than the predetermined value. This reliably suppresses convection occurring in an interface between a liquid layer containing the first lower surface-tension liquid and a liquid layer containing the second lower surface-tension liquid due to the Marangoni effect. That is, an experimentally determined boundary value at which the Marangoni effect does not occur is employed as the predetermined value. Thus, the second lower surface-tension liquid can be evenly dissolved in the liquid mass present on the substrate. More specifically, the predetermined value is, for example, 20 mN/m.

The method may further comprise a substrate rotating step of rotating the substrate, the substrate rotating step being performed in parallel to the pre-drying liquid supplying step and the vapor supplying step.

In this case, the substrate is rotated in the pre-drying liquid supplying step and the vapor supplying step, whereby the liquid mass containing the treatment liquid on the substrate is partly spun off from the substrate by a centrifugal force generated by the rotation of the substrate. Therefore, the treatment liquid remaining on the major surface of the substrate can be efficiently removed from the substrate.

By rotating the substrate, most of the liquid mass present on the substrate can be speedily removed from the substrate. This reduces the thickness of the liquid mass present on the surface of the substrate, and reduces the amount of the treatment liquid to be evaporated. Therefore, the treatment liquid remaining on the substrate surface can be evaporated in a shorter period of time.

The vapor supplying step may include the step of keeping a substrate opposing surface of a substrate opposing member in opposed relation to the major surface of the substrate, and the step of supplying the vapor into a space defined between the substrate opposing surface and the major surface kept in opposed relation to each other.

In this case, the vapor of the second lower surface-tension liquid is supplied into the space between the substrate opposing surface of the substrate opposing member and the major surface of the substrate kept in opposed relation to each other, whereby diffusion of the vapor is suppressed. Thus, the vapor can be efficiently supplied to the major surface of the substrate at a higher concentration. This reduces the consumption of the vapor of the second lower surface-tension liquid.

The vapor supplying step may include the step of heating the substrate opposing surface and a flow pipe though which the vapor flows. Where the vapor supplying step includes the heating step, the vapor supplying step is preferably the step of supplying the vapor to the major surface with the substrate opposing surface and the flow pipe kept at a temperature higher than a condensation temperature of the vapor of the second lower surface-tension liquid.

That is, where the substrate opposing surface and the flow pipe through which the vapor of the second lower surface-tension liquid flows are kept at a temperature higher than the condensation temperature of the vapor of the second lower surface-tension liquid, waste of the vapor of the second lower surface-tension liquid is suppressed which may otherwise result from the condensation of the vapor on the substrate opposing surface and in the flow pipe. Thus, the consumption of the vapor of the second lower surface-tension liquid is reduced.

The vapor supplying step is preferably the step of supplying the vapor to the major surface with the major surface kept at a temperature not higher than a predetermined temperature. The predetermined temperature is a temperature of the second lower surface-tension liquid at which a condensation partial vapor pressure of the second lower surface-tension liquid is equal to a saturation vapor pressure of the second lower surface-tension liquid. That is, the predetermined temperature is a temperature of the second lower surface-tension liquid observed when the partial vapor pressure of the second lower surface-tension liquid is equal to the saturation vapor pressure at which the vapor of the second lower surface-tension liquid is condensed.

In the vapor supplying step, the vapor of the second lower surface-tension liquid is condensed on the substrate by keeping the major surface of the substrate at the temperature not higher than the temperature of the second lower surface-tension liquid at which the condensation partial vapor pressure of the second lower surface-tension liquid is equal to the saturation vapor pressure. That is, the vapor of the second lower surface-tension liquid can be efficiently supplied to the major surface of the substrate. This further reduces the consumption of the vapor of the second lower surface-tension liquid. Further, the major surface of the substrate is kept covered with the second lower surface-tension liquid by the efficient supply of the vapor of the second lower surface-tension liquid to the major surface of the substrate.

The method may further comprise the step of drying the substrate by removing the liquid mass adhering to the major surface of the substrate after the vapor supplying step.

As described above, the treatment liquid is not present on the substrate after the vapor supplying step, but only the first and second lower surface-tension liquids each having a lower surface tension than the deionized water are present on the substrate. This makes it possible to dry the substrate in a shorter period of time while suppressing the defects resulting from improper drying.

A substrate treatment apparatus according to the present invention comprises a substrate holding unit, a treatment liquid supplying unit, a pre-drying liquid supplying unit, a vapor supplying unit and a control unit. The substrate holding unit holds a substrate. The treatment liquid supplying unit supplies a treatment liquid to a major surface of the substrate. The pre-drying liquid supplying unit supplies a first lower surface-tension liquid having a lower surface tension than deionized water to the major surface of the substrate. The vapor supplying unit supplies vapor of a second lower surface-tension liquid having a lower surface tension than the deionized water and soluble in the first lower surface-tension liquid to the major surface of the substrate. The control unit controls the substrate holding unit, the treatment liquid supplying unit, the pre-drying liquid supplying unit and the vapor supplying unit to perform a treatment liquid supplying step, a pre-drying liquid supplying step and a vapor supplying step. In the treatment liquid supplying step, the treatment liquid is supplied from the treatment liquid supplying unit to the major surface of the substrate held by the substrate holding unit. In the pre-drying liquid supplying step, the first lower surface-tension liquid is supplied from the pre-drying liquid supplying unit to the major surface of the substrate held by the substrate holding unit after the treatment liquid supplying step. In the vapor supplying step, the vapor of the second lower surface-tension liquid is supplied from the vapor supplying unit to the major surface of the substrate held by the substrate holding unit after the pre-drying liquid supplying step.

The foregoing and other objects, features and effects of the present invention will become more apparent from the following detailed description of preferred embodiments with reference to the attached drawings.

### BRIEF DESCRIPTION OF THE DRAWINGS

FIG. 1 is a schematic diagram for explaining the construction of a substrate treatment apparatus according to one embodiment of the present invention.

FIG. 2 is a block diagram for explaining an arrangement for controlling the substrate treatment apparatus.

FIGS. 3(a), 3(b), 3(c) and 3(d) are diagrams for explaining an exemplary wafer treatment process to be performed by the substrate treatment apparatus.

FIGS. 4(a), 4(b) and 4(c) are diagrams for explaining treatment states in the exemplary wafer treatment process.

FIG. 5 is a diagram for explaining another exemplary wafer treatment process to be performed by the substrate treatment apparatus.

FIG. 6 is a diagram for explaining further another exemplary wafer treatment process to be performed by the substrate treatment apparatus.

FIG. 7 is a diagram for explaining still another exemplary wafer treatment process to be performed by the substrate treatment apparatus.

### DETAILED DESCRIPTION OF PREFERRED EMBODIMENTS

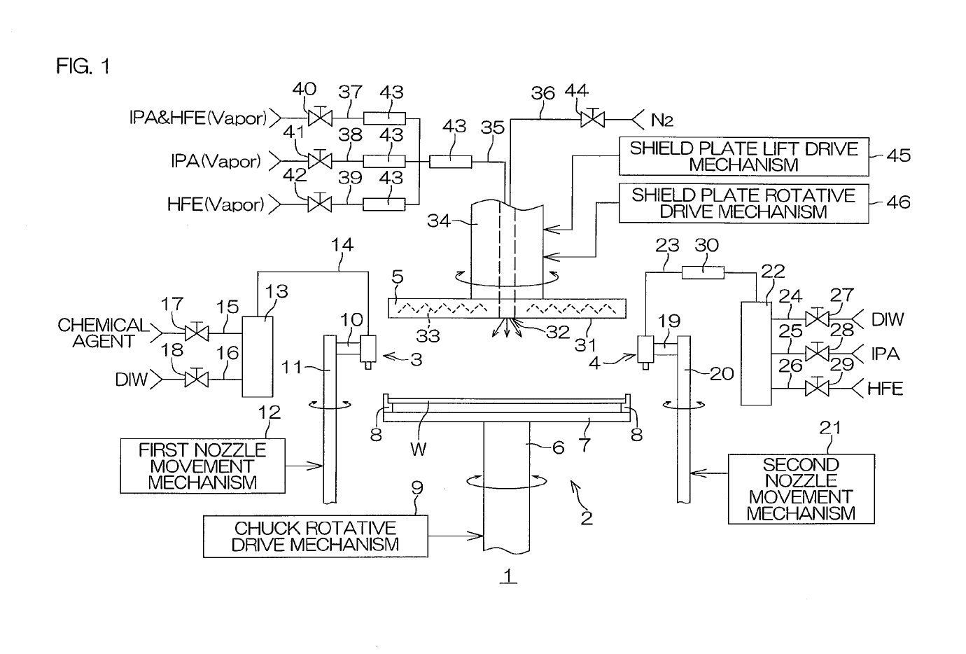

FIG. 1 is a schematic diagram for explaining the construction of a substrate treatment apparatus 1 according to one embodiment of the present invention. The substrate treatment apparatus 1 is of a single substrate treatment type which is configured to treat a semiconductor wafer W as a substrate (hereinafter referred to simply as “wafer W”) with a treatment liquid. The substrate treatment apparatus 1 includes a spin chuck 2 (substrate holding unit), a first nozzle 3 (treatment liquid supplying unit) and a second nozzle 4 (treatment liquid supplying unit, pre-drying liquid supplying unit), and a shield plate 5 (substrate opposing member). The spin chuck 2 generally horizontally holds and rotates the wafer W. The first nozzle 3 and the second nozzle 4 each supply a treatment liquid to a front surface (upper surface) of the wafer W held by the spin chuck 2. The shield plate 5 is disposed above the spin chuck 2.

The spin chuck 2 includes a rotation shaft 6 extending vertically, and a disk-shaped spin base 7 horizontally fixed to an upper end of the rotation shaft 6. The spin chuck 2 is capable of generally horizontally holding the wafer W by a plurality of chuck pins 8 projecting upright from a peripheral edge of an upper surface of the spin base 7. That is, the chuck pins 8 are arranged circularly in association with an outer periphery of the wafer W in properly spaced relation on the peripheral edge of the upper surface of the spin base 7. The chuck pins 8 support a peripheral edge of a rear surface (lower surface) of the wafer W in abutment against the circumferential surface of the wafer W at different positions, thereby cooperatively holding the wafer W generally horizontally.

A chuck rotative drive mechanism 9 including a drive source such as a motor is connected to the rotation shaft 6. A driving force is inputted to the rotation shaft 6 from the chuck rotative drive mechanism 9 with the wafer W being held by the chuck pins 8, whereby the wafer W is rotated about a vertical axis extending through the center of the front surface of the wafer W.

It is noted that the construction of the spin chuck 2 is not limited to the aforementioned one, but a spin chuck of a vacuum suction type (vacuum chuck), for example, may be employed which is configured to generally horizontally hold the wafer W by sucking the rear surface of the wafer W by vacuum and, in this state, turn about a vertical axis to rotate the wafer W held thereby.

The first nozzle 3 is, for example, a straight nozzle which spouts the treatment liquid in the form of continuous flow. The first nozzle 3 is attached to a distal end of a generally horizontally extending arm 10 with its outlet facing toward the wafer W (downward). The arm 10 is supported by a support shaft 11 extending generally vertically, and extends generally horizontally from an upper end of the support shaft 11.

The support shaft 11 is rotatable about its center axis. The support shaft 11 is connected to a first nozzle movement mechanism 12 which rotates the support shaft 11 to generally horizontally move the first nozzle 3. The first nozzle 3 is generally horizontally moved by the first nozzle movement mechanism 12 to be located above the wafer W held by the spin chuck 2 and retracted from above of the wafer W.

The treatment liquid is supplied to the first nozzle 3 from a first treatment liquid supply pipe 14 through a manifold 13. More specifically, a chemical agent or a rinse liquid is supplied to the first nozzle 3. Usable as the chemical agent is, for example, a liquid containing at least one of sulfuric acid, acetic acid, nitric acid, hydrochloric acid, hydrofluoric acid, ammonia water and hydrogen peroxide water. Examples of the rinse liquid include pure water, DIW (deionized water), carbonated water, electrolyzed ion water, hydrogen water, magnetic water, and diluted ammonia water having a reduced concentration (e.g., about 1 ppm). In this embodiment, the DIW is employed as the rinse liquid.

A chemical agent supply pipe 15 and a DIW supply pipe 16 are connected to the manifold 13. The chemical agent is supplied to the manifold 13 through the chemical agent supply pipe 15, and the DIW is supplied to the manifold 13 through the DIW supply pipe 16. When the chemical agent or the DIW is supplied to the manifold 13, the supplied chemical agent or DIW is further supplied to the first nozzle 3 through the first treatment liquid supply pipe 14 to be spouted from the first nozzle 3.

A chemical agent valve 17 is provided in the chemical agent supply pipe 15, and the supply of the chemical agent to the manifold 13 is controlled by opening and closing the chemical agent valve 17. A DIW valve 18 is provided in the DIW supply pipe 16, and the supply of the DIW to the manifold 13 is controlled by opening and closing the DIW valve 18. Therefore, the chemical agent or the DIW can be supplied to the first nozzle 3 by controlling the opening and closing of the chemical agent valve 17 and the DIW valve 18.

The second nozzle 4 is, for example, a straight nozzle which spouts the treatment liquid in the form of continuous flow. The second nozzle 4 is attached to a distal end of a generally horizontally extending arm 19 with its outlet facing toward the wafer W (downward). The arm 19 is supported by a support shaft 20 extending generally vertically, and extends generally horizontally from an upper end of the support shaft 20.

The support shaft 20 is rotatable about its center axis. The support shaft 20 is connected to a second nozzle movement mechanism 21 which rotates the support shaft 20 to generally horizontally move the second nozzle 4. The second nozzle 4 is generally horizontally moved by the second nozzle movement mechanism 21 to be located above the wafer W held by the spin chuck 2 and retracted from above of the wafer W.

The treatment liquid is supplied to the second nozzle 4 from a second treatment liquid supply pipe 23 through a manifold 22. More specifically, DIW or a liquid organic solvent is supplied to the second nozzle 4. The organic solvent is lower in surface tension and higher in volatility than deionized water. More specifically, a liquid containing at least one of IPA, an HFE (hydrofluoroether), methanol, ethanol, acetone and trans-1,2-dichloroethylene, for example, is employed as the organic solvent.

In this embodiment, the IPA and the HFE are supplied as the organic solvent to the second nozzle 4. The IPA is soluble in the DIW, and the HFE is substantially insoluble in the DIW. Further, the IPA is soluble in the HFE.

Usable as the HFE are, for example, HFEs available under the trade name of NOVEC (registered trademark) from Sumitomo 3M Ltd. Specific examples of the HFEs include HFE-7100 (trade name) represented by a chemical formula C₄F₉OCH₃, HFE-7200 (trade name) represented by a chemical formula C₄F₉OC₂H₅ and HFE-7300 (trade name) represented by a chemical formula C₆F₁₃OCH₃. In this embodiment, HFE-7100 is employed as the HFE.

The IPA has a surface tension of 20.9 mN/m (at 25° C.) HFE-7100, HFE-7200 and HFE-7300 have surface tensions of 13.6 mN/m, 13.6 mN/m and 15.0 mN/m, respectively, at 25° C. Therefore, the surface tensions of these organic solvents are lower than the surface tension of the deionized water (72 mN/m at 25° C.).

For indication of volatility, the boiling points of the IPA, HFE-7100, HFE-7200 and HFE-7300 at atmospheric pressure are 82° C., 61° C., 76° C. and 98° C., respectively. That is, these organic solvents are lower in boiling point than the deionized water (having a boiling point of 100° C. at atmospheric pressure), and hence higher in volatility than the deionized water.

A DIW supply pipe 24, an IPA supply pipe 25 and an HFE supply pipe 26 are connected to the manifold 22. The DIW is supplied to the manifold 22 through the DIW supply pipe 24, and the liquid IPA is supplied to the manifold 22 through the IPA supply pipe 25. The liquid HFE is supplied to the manifold 22 through the HFE supply pipe 26.

A DIW valve 27 is provided in the DIW supply pipe 24, and the supply of the DIW to the manifold 22 is controlled by opening and closing the DIW valve 27. An IPA valve 28 is provided in the IPA supply pipe 25, and the supply of the IPA to the manifold 22 is controlled by opening and closing the IPA valve 28. Further, an HFE valve 29 is provided in the BFE supply pipe 26, and the supply of the HFE to the manifold 22 is controlled by opening and closing the HFE valve 29.

Therefore, at least one of the DIW, the IPA and the HFE is supplied as the treatment liquid to the manifold 22 by controlling the opening and closing of the DIW valve 27, the IPA valve 28 and the HFE valve 29. When two or more of the DIW, the IPA and the HFE are supplied as treatment liquids to the manifold 22, the supplied treatment liquids are mixed in the manifold 22 to provide a treatment liquid mixture, which is in turn supplied to the second treatment liquid supply pipe 23. Further, the treatment liquid mixture supplied to the second treatment liquid supply pipe 23 is stirred in a stirring-finned flow pipe 30 (stirring unit) provided in the second treatment liquid supply pipe 23. Thus, the treatment liquid mixture sufficiently mixed is supplied to the second nozzle 4 through the second treatment liquid supply pipe 23, and spouted from the second nozzle 4.

The stirring-finned flow pipe 30 includes a pipe member, and a plurality of stirring fins of rectangular plates which are each twisted approximately 180 degrees about an axis extending in a liquid flow direction and arranged along a pipe axis extending in the liquid flow direction in the pipe member with their twist angular positions alternately offset by 90 degrees. For example, an inline mixer available from Noritake Company Limited and Advance Electric Company Incorporated under the trade name of MX Series Inline Mixer may be employed.

The shield plate 5 is a disk-shaped member having substantially the same diameter as the wafer W (or a slightly greater diameter than the wafer W), and is disposed generally horizontally above the spin chuck 2. A lower surface of the shield plate 5 serves as a substrate opposing surface 31 which is brought into opposed relation to the front surface of the wafer W held by the spin chuck 2, and has an opening 32 formed at the center thereof. The opening 32 communicates with a through-hole which extends through the shield plate 5. A heater 33 is incorporated in the shield plate 5, and the substrate opposing surface 31 is entirely heated to a predetermined temperature by the heater 33.

A support shaft 34 is connected to an upper surface of the shield plate 5 as extending coaxially with the rotation shaft 6 of the spin chuck 2. The support shaft 34 is a hollow shaft, and an inner space of the support shaft 34 communicates with the through-hole. The inner space of the support shaft 34 also communicates with a vapor supply pipe 35 (flow pipe, vapor supply unit) and a gas supply pipe 36 which are connected to the support shaft 34. An organic solvent vapor is supplied to the inner space of the support shaft 34 through the vapor supply pipe 35, and an inert gas is supplied to the inner space of the support shaft 34 through the gas supply pipe 36. The organic solvent vapor is vapor of an organic solvent which is lower in surface tension and higher in volatility than the deionized water.

In this embodiment, vapor of IPA (hereinafter referred to as “IPA vapor”), vapor of an HFE (hereinafter referred to as “HFE vapor”) and vapor of an IPA/HFE mixture (hereinafter referred to as “mixture vapor”) are supplied as the organic solvent vapor to the inner space of the support shaft 34. Examples of the inert gas include nitrogen gas, argon gas and helium gas. In this embodiment, the nitrogen gas is employed as the inert gas.

Usable as the IPA/HFE mixture is, for example, a mixture containing HFE-7100 (95%) and IPA (5%). This mixture has a boiling point of 54.5° C. at atmospheric pressure and a surface tension of 14.0 mN/m (at 25° C.).

A first supply pipe 37 (flow pipe, vapor supply unit), a second supply pipe 38 (flow pipe, vapor supply unit) and a third supply pipe 39 (flow pipe, vapor supply unit) are connected to the vapor supply pipe 35. The mixture vapor is supplied to the vapor supply pipe 35 through the first supply pipe 37, and the IPA vapor is supplied to the vapor supply pipe 35 through the second supply pipe 38. Further, the HFE vapor is supplied to the vapor supply pipe 35 through the third supply pipe 39.

A first valve 40 is provided in the first supply pipe 37, and the supply of the mixture vapor to the vapor supply pipe 35 is controlled by opening and closing the first valve 40. A second valve 41 is provided in the second supply pipe 38, and the supply of the IPA vapor to the vapor supply pipe 35 is controlled by opening and closing the second valve 41. Further, a third valve 42 is provided in the third supply pipe 39, and the supply of the HFE vapor to the vapor supply pipe 35 is controlled by opening and closing the third valve 42.

Therefore, at least one of the IPA vapor, the HFE vapor and the mixture vapor is supplied to the vapor supply pipe 35 by controlling the opening and closing of the first valve 40, the second valve 41 and the third valve 42. The vapor supplied to the vapor supply pipe 35 is ejected downward from the opening 32 formed in the substrate opposing surface 31 through the inner space of the support shaft 34.

Pipe heaters 43 for heating the vapor supply pipe 35, the first supply pipe 37, the second supply pipe 38 and the third supply pipe 39 to predetermined temperatures are respectively provided in walls of these supply pipes 35, 37, 38, 39. The inner wall temperatures of the supply pipes 35, 37 to 39 are respectively kept at levels higher than the condensation temperatures of the organic solvent vapors flowing through the supply pipes 35, 37 to 39 by the heaters 43. Though not shown, a heater is also provided in the support shaft 34, and the inner wall temperature of the support shaft 34 is kept at a level higher than the condensation temperature of the organic solvent vapor flowing through the support shaft 34 by this heater. Further, the temperature of the substrate opposing surface 31 is kept at a level higher than the condensation temperature of the organic solvent vapor ejected from the opening 32 by the heater 33 incorporated in the shield plate 5.

A gas valve 44 is provided in the gas supply pipe 36, and the supply of the nitrogen gas to the inner space of the support shaft 34 is controlled by opening and closing the gas valve 44. The nitrogen gas supplied to the inner space of the support shaft 34 is ejected downward from the opening 32 formed in the substrate opposing surface 31.

A shield plate lift drive mechanism 45 and a shield plate rotative drive mechanism 46 are connected to the support shaft 34. The shield plate lift drive mechanism 45 vertically moves the support shaft 34 and the shield plate 5, whereby the shield plate 5 is moved up and down to be located at a proximate position in proximity to the front surface of the wafer W held by the spin chuck 2 and significantly retracted to a retracted position above the spin chuck 2. Further, the shield plate rotative drive mechanism 46 rotates the support shaft 34 and the shield plate 5 substantially in synchronism with the rotation of the wafer W by the spin chuck 2 (or at a rotation speed slightly different from the rotation speed of the wafer W). The shield plate 5 may be fixed with respect to the direction of the rotation without the provision of the shield plate rotative drive mechanism 46.

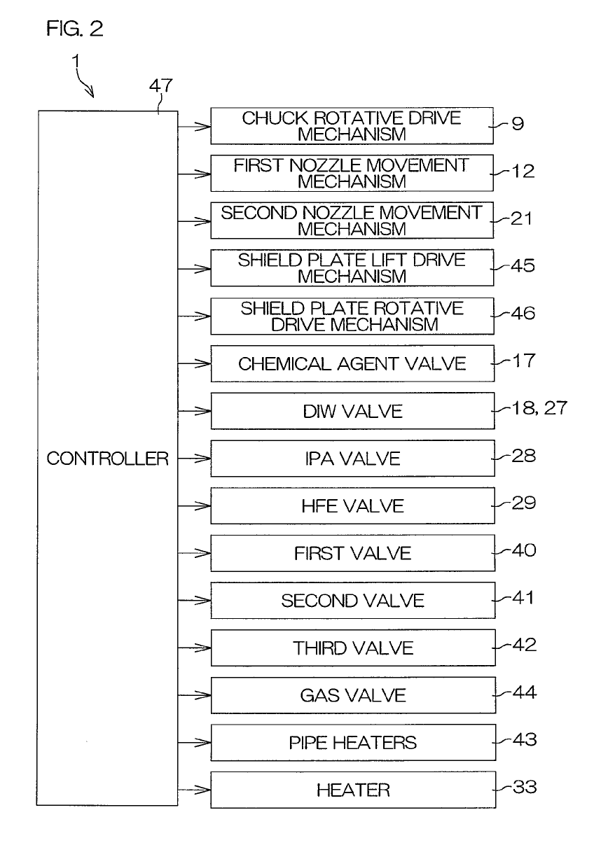

FIG. 2 is a block diagram for explaining an arrangement for controlling the substrate treatment apparatus 1. The substrate treatment apparatus 1 includes a controller 47 (control unit). The controller 47 controls the operations of the chuck rotative drive mechanism 9, the first nozzle movement mechanism 12, the second nozzle movement mechanism 21, the shield plate lift drive mechanism 45 and the shield plate rotative drive mechanism 46. Further, the controller 47 controls the opening and closing of the chemical agent valve 17, the DIW valves 18, 27, the IPA valve 28, the HFE valve 29, the first valve 40, the second valve 41 and the third valve 42. Furthermore, the controller 47 controls the ON/OFF of the heater 33 and the pipe heaters 43, and the heating temperatures of the heater 33 and the pipe heaters 43.

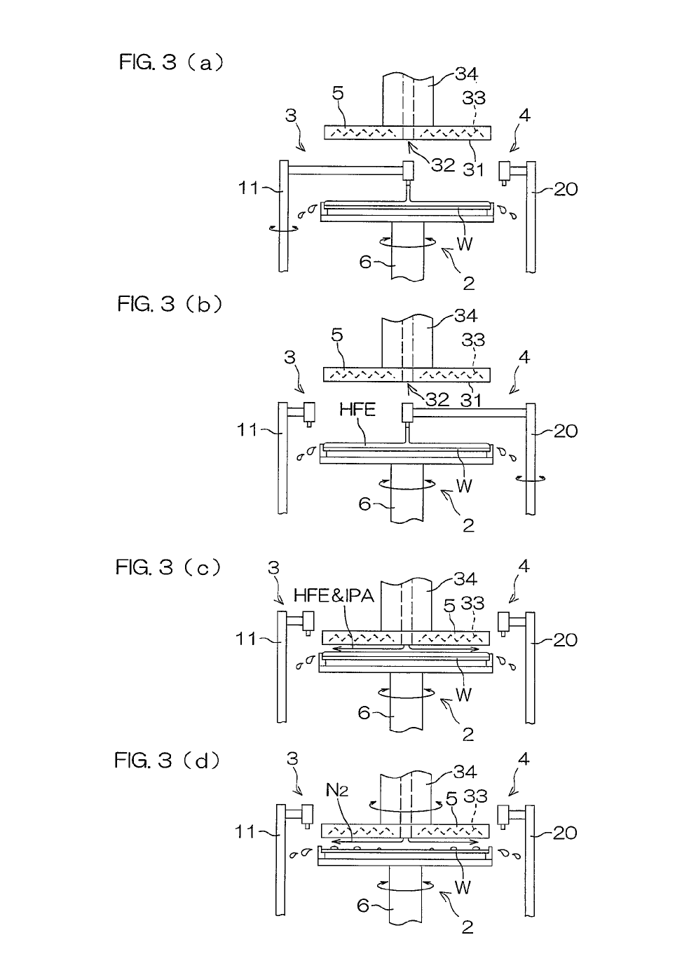

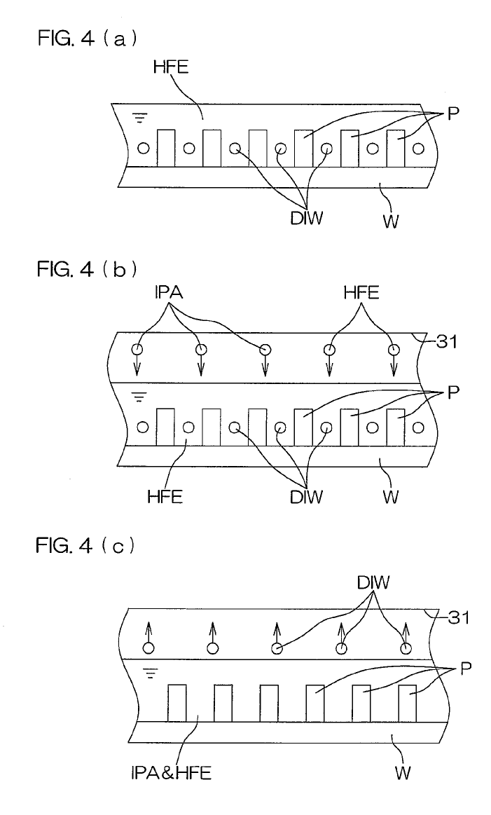

FIGS. 3(a), 3(b), 3(c) and 3(d) are diagrams for explaining an exemplary wafer treatment process to be performed by the substrate treatment apparatus 1. FIGS. 4(a), 4(b) and 4(c) are diagrams for explaining treatment states in the exemplary wafer treatment process. In the following, reference is made mainly to FIGS. 1, 2, 3(a), 3(b), 3(c), 3(c) and 3(d) and, as required, to FIGS. 4(a), 4(b) and 4(c).

A wafer W to be treated is transported to the apparatus 1 by a transport robot not shown, and transferred to the spin chuck 2 from the transport robot. After the wafer W is transferred to the spin chuck 2, the controller 47 controls the chuck rotative drive mechanism 9 to rotate the wafer W held by the spin chuck 2 at a predetermined rotation speed. Further, the controller 47 controls the first nozzle movement mechanism 12 to locate the first nozzle 3 above the wafer W held by the spin chuck 2. At this time, the controller 47 controls the shield plate lift drive mechanism 45 to significantly retract the shield plate 5 above the spin chuck 2.

Thereafter, the controller 47 opens the chemical agent valve 17 to supply the chemical agent toward a rotation center of a front surface of the wafer W from the first nozzle 3 as shown in FIG. 3(a). The chemical agent supplied to the front surface of the wafer W instantaneously spreads over the entire front surface of the wafer W by a centrifugal force generated by the rotation of the wafer W. Thus, a chemical agent treatment process is performed to treat the entire front surface of the wafer W with the chemical agent.

After the chemical agent is supplied for a predetermined chemical treatment period, the controller 47 closes the chemical agent valve 17 to stop the supply of the chemical agent from the first nozzle 3. Thereafter, the controller 47 opens the DIW valve 18 to supply the DIW toward the rotation center of the front surface of the wafer W from the first nozzle 3 (treatment liquid supplying step).

The DIW supplied to the front surface of the wafer W instantaneously spreads over the entire front surface of the wafer W by the centrifugal force generated by the rotation of the wafer W. Thus, the chemical agent remaining on the front surface of the wafer W is rinsed away to be replaced with the DIW. In this manner, a rinsing process is performed on the entire front surface of the wafer W.

After the DIW is supplied for a predetermined rinsing period, the controller 47 closes the DIW valve 18 to stop the supply of the DIW from the first nozzle 3. Thereafter, the controller 47 controls the first nozzle movement mechanism 12 to retract the first nozzle 3 from above of the wafer W. Then, the controller 47 controls the second nozzle movement mechanism 21 to locate the second nozzle 4 above the wafer W held by the spin chuck 2. Subsequently, the controller 47 opens the HFE valve 29 to supply the liquid HFE as a first lower surface-tension liquid toward the rotation center of the front surface of the wafer W from the second nozzle 4 as shown in FIG. 3(b) (pre-drying liquid supplying step).

The HFE supplied to the front surface of the wafer W instantaneously spreads over the entire front surface of the wafer W by the centrifugal force generated by the rotation of the wafer W. Thus, the DIW adhering to the front surface of the wafer W after the rinsing process is mostly washed away to be replaced with the HFE. That is, as shown in FIG. 4(a), most of the DIW adhering to the front surface of the wafer W after the rinsing process, except a trace amount of DIW intruding into inner portions of a pattern P formed on the front surface of the wafer W, is replaced with the HFE. Thus, the front surface of the wafer W is entirely covered with the HFE.

Since the DIW adhering to the front surface of the wafer W is not entirely but mostly replaced with the HFE, an HFE supply period can be reduced. This reduces the overall wafer treatment period. Since the consumption of the HFE is correspondingly reduced, the running costs of the apparatus are reduced.

Further, the wafer W is rotated at the predetermined rotation speed during the supply of the HFE to the front surface of the wafer W, so that the DIW and the HFE are moved toward the periphery of the wafer W by the centrifugal force to be mostly expelled from the wafer W. Since the amount of a liquid mass present on the front surface of the wafer W is reduced, the amount of the liquid mass to be removed is reduced. Therefore, the removal of the liquid mass can be efficiently achieved.

After the HFE is supplied for a predetermined pre-wetting period, the controller 47 closes the HFE valve 29 to stop the supply of the HFE from the second nozzle 4, and controls the second nozzle movement mechanism 21 to retract the second nozzle 4 from above of the wafer W. Thereafter, the controller 47 controls the shield plate lift drive mechanism 45 to move down the shield plate 5. Thus, the substrate opposing surface 31 of the shield plate 5 is located in proximity to the front surface of the wafer W held by the spin chuck 2.

Then, the controller 47 opens the first valve 40 to eject the mixture vapor (IPA/HFE mixture vapor) as vapor of a second lower surface-tension liquid from the opening 32 of the substrate opposing surface 31 toward the rotation center of the front surface of the wafer W. The ejected mixture vapor spreads toward the periphery of the wafer W between the front surface of the wafer W and the substrate opposing surface 31 as shown in FIG. 3(c). Thus, a space defined between the front surface of the wafer W and the substrate opposing surface 31 is filled with the mixture vapor, whereby the mixture vapor is supplied to the entire front surface of the wafer W (vapor supplying step).

At this time, the substrate opposing surface 31 is located in proximity to the front surface of the wafer W. Therefore, the mixture vapor ejected from the opening 32 is prevented from diffusing upward to be thereby efficiently supplied to the front surface of the wafer W. That is, the mixture vapor is efficiently supplied at a high concentration to the front surface of the wafer W. Since the space between the front surface of the wafer W and the substrate opposing surface 31 is narrow, only a small amount of the mixture vapor is required for filling the space.

During the supply of the mixture vapor to the front surface of the wafer W, the internal temperatures of the first supply pipe 37 and the vapor supply pipe 35 and the temperature of the inner space of the support shaft 34 are kept at a level (e.g., 55° C. or higher) higher than the condensation temperature (54.5° C.) of the mixture vapor. Further, the temperature of the substrate opposing surface 31 is kept at a level (e.g., 55° C. or higher) higher than the condensation temperature of the mixture vapor during the supply of the mixture vapor to the front surface of the wafer W. On the other hand, the temperature of the front surface of the wafer W is kept at a room temperature (e.g., about 25° C.) which is lower than the condensation temperature of the mixture vapor during the supply of the mixture vapor to the front surface of the wafer W.

Therefore, the mixture vapor supplied to the front surface of the wafer W is not wasted due to condensation thereof during the flow before the ejection thereof from the opening 32, but is efficiently supplied to the space between the front surface of the wafer W and the substrate opposing surface 31. Further, the mixture vapor ejected from the opening 32 is not wasted due to condensation thereof on the substrate opposing surface 31, but is efficiently supplied toward the front surface of the wafer W as shown in FIG. 4(b). Furthermore, the mixture vapor supplied to the front surface of the wafer W is liquefied on the front surface of the wafer W (more specifically, on the surface of the liquid mass remaining on the front surface of the wafer W) because the front surface of the wafer W is kept at a temperature not higher than the dew point of the mixture vapor. Thus, a mixture of the IPA and the HFE (hereinafter referred to as “organic solvent mixture”) is efficiently supplied to the front surface of the wafer W. With the mixture vapor thus liquefied, the front surface of the wafer W is kept covered with a film of the organic solvent mixture.

The organic solvent mixture supplied to the front surface of the wafer W is evenly dissolved in the liquid mass remaining on the front surface of the wafer W. That is, the organic solvent mixture supplied to the front surface of the wafer W is satisfactorily dissolved in the liquid mass remaining on the wafer W, because the liquid mass is mostly the HFE soluble in the organic solvent mixture. Since a difference in surface tension between the HFE accounting for most of the liquid mass remaining on the wafer W and the organic solvent mixture is not greater than a predetermined value (e.g., 20 mN/m), it is possible to evenly dissolve the organic solvent mixture in the liquid mass remaining on the front surface of the wafer W while suppressing the convection occurring due to the Marangoni effect.

Therefore, the liquid mass remaining on the front surface of the wafer W is washed away together with the organic solvent mixture from the wafer W to be finally replaced with the organic solvent mixture by continuously supplying the mixture vapor to the front surface of the wafer W. Further, the trace amount of the DIW contained in the liquid mass remaining on the front surface of the wafer W is dissolved in the IPA contained in the organic solvent mixture to be diffused into the liquid mass by dissolving the organic solvent mixture in the liquid mass. Thus, the trace amount of the DIW remaining on the front surface of the wafer W is evaporated from the surface of the organic solvent mixture as shown in FIG. 4(c). In this manner, the DIW is completely removed from the front surface of the wafer W. At this time, an excess amount of the liquid mass remaining on the front surface of the wafer W is preliminarily removed by rotating the wafer W by the spin chuck 2, so that the remaining liquid mass has a smaller thickness. Therefore, the DIW is readily evaporated.

The collapse of the pattern occurring due to the surface tension of the DIW is suppressed by the complete removal of the DIW from the front surface of the wafer W. Further, the trace amount of the DIW remaining on the front surface of the wafer W is not evaporated from the front surface of the wafer W but from the surface of the organic solvent mixture. Therefore, water marks and other defects on the front surface of the wafer W can be suppressed which may otherwise result from improper drying.

After the mixture vapor is supplied for a predetermined treatment period, the controller 47 closes the first valve 40 to stop the ejection of the mixture vapor. Thereafter, the controller 47 opens the gas valve 44 to eject the nitrogen gas from the opening 32 of the substrate opposing surface 31 toward the rotation center of the front surface of the wafer W. At the same time, the controller 47 controls the chuck rotative drive mechanism 9 to change the rotation speed of the wafer W rotated by the spin chuck 2 to a predetermined higher rotation speed, and controls the shield plate rotative drive mechanism 46 to rotate the support shaft 34 and the shield plate 5 substantially in synchronism with the rotation of the wafer W rotated by the spin chuck 2 (or at a rotation speed slightly different from the rotation speed of the wafer W). Alternatively, the support shaft 34 and the shield plate 5 may be kept in a non-rotative state without the rotation control of the support shaft 34 and the shield plate 5 by the shield plate rotative drive mechanism 46.

As shown in FIG. 3(d), the ejected nitrogen gas spreads toward the periphery of the wafer W in the space between the front surface of the wafer W and the substrate opposing surface 31 by air streams generated by the rotation of the wafer W and the rotation of the shield plate 5. Thus, the space between the front surface of the wafer W and the substrate opposing surface 31 is filled with the nitrogen gas, whereby the nitrogen gas is supplied to the entire front surface of the wafer W.

The liquid mass (organic solvent mixture) remaining on the front surface of the wafer W is spun off around the wafer W by a centrifugal force generated by the rotation of the wafer W (substrate drying step). Thus, the liquid mass is removed from the front surface of the wafer W, whereby the front surface of the wafer W is dried. At this time, the liquid mass is removed from the front surface of the wafer W in a shorter period of time, because an excess amount of the liquid mass remaining on the front surface of the wafer W is preliminarily removed by rotating the wafer W by the spin chuck 2. Thus, a substrate drying period is reduced. Further, an oxygen concentration in the space between the front surface of the wafer W and the substrate opposing surface 31 is reduced by filling the space with the nitrogen gas, so that the formation of the water marks can be suppressed. Since the liquid mass remaining on the front surface of the wafer W is the organic solvent mixture having a lower surface tension than the deionized water, the collapse of the pattern and other damages to the wafer W can be suppressed.

After a spin drying process is thus performed for a predetermined spin drying period, the controller 47 controls the chuck rotative drive mechanism 9 to cause the spin chuck 2 to stop the rotation of the wafer W, and closes the gas valve 44 to stop the ejection of the nitrogen gas from the opening 32. Further, the controller 47 controls the shield plate rotative drive mechanism 46 to stop the rotation of the shield plate 5 (if the rotation of the shield plate 5 is already stopped, the control of the shield plate rotative drive mechanism 46 is obviated), and controls the shield plate lift drive mechanism 45 to significantly retract the shield plate 5 above the spin chuck 2. Then, the transport robot not shown transports the treated wafer W from the spin chuck 2.

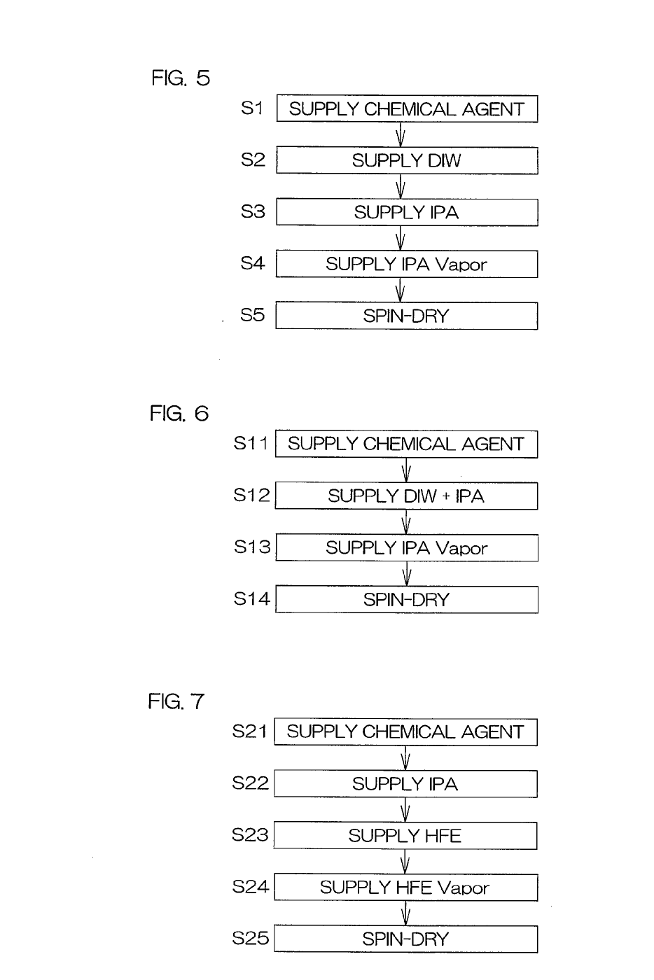

FIG. 5 is a diagram for explaining another exemplary wafer treatment process to be performed by the substrate treatment apparatus 1. With reference to FIGS. 1, 3(a), 3(b), 3(c), 3(d) and 5, a difference between the wafer treatment process shown in FIG. 5 and the wafer treatment process shown in FIGS. 3(a), 3(b), 3(c) and 3(d) will hereinafter be described.

A major difference between the wafer treatment process shown in FIG. 5 and the wafer treatment process shown in FIGS. 3(a), 3(b), 3(c) and 3(d) is that the IPA is employed as the first lower surface-tension liquid, and the IPA vapor is employed as the vapor of the second lower surface-tension liquid.

In the wafer treatment process shown in FIG. 5, more specifically, the chemical treatment process and the rinsing process are sequentially performed on the front surface of the wafer W by sequentially supplying the chemical agent and the rinse liquid to the front surface of the wafer W (Steps S1, S2) as in the wafer treatment process shown in FIGS. 3(a), 3(b), 3(c) and 3(d). After the rinsing process is performed on the front surface of the wafer W, the controller 47 opens the IPA valve 28 to supply the IPA as the first lower surface-tension liquid from the second nozzle 4 toward the rotation center of the front surface of the wafer W held by the spin chuck 2 (pre-drying liquid supplying step, Step S3). The IPA supplied to the front surface of the wafer W instantaneously spreads over the entire front surface of the wafer W by the centrifugal force generated by the rotation of the wafer W. Thus, the DIW remaining on the front surface of the wafer W is mostly replaced with the IPA. Further, the DIW still remaining on the front surface of the wafer W without replacement with the IPA is dissolved in the IPA supplied to the front surface of the wafer W, because the IPA is soluble in the DIW.

After the completion of the pre-drying liquid supplying step, the controller 47 controls the shield plate lift drive mechanism 45 to locate the substrate opposing surface 31 of the shield plate 5 in proximity to the front surface of the wafer W, and opens the second valve 41 to eject the IPA vapor as the vapor of the second lower surface-tension liquid from the opening 32 of the substrate opposing surface 31 (vapor supplying step, Step S4). The ejected IPA vapor is supplied to the entire front surface of the wafer W, and is dissolved in a liquid mass remaining on the front surface of the wafer W. That is, the liquid mass remaining on the front surface of the wafer W consists of the IPA and the DIW, so that the supplied IPA vapor is satisfactorily dissolved in the liquid mass. At the same time, the DIW still remaining on the front surface of the wafer W without the replacement with the IPA in the pre-drying liquid supplying step is evaporated from the surface of the liquid mass on the wafer W. Thus, the DIW is completely removed from the front surface of the wafer W.

The liquid mass remaining on the front surface of the wafer W after the pre-drying liquid supplying step is mostly the IPA. Therefore, the supply of the IPA vapor in the vapor supplying step makes it possible to dissolve the IPA in the liquid mass on the wafer W while suppressing the convection occurring in the liquid mass on the wafer W due to the Marangoni effect. Since the DIW still remaining on the front surface of the wafer W without the replacement with the IPA in the pre-drying liquid supplying step is already dissolved in the IPA, the DIW can be efficiently removed from the front surface of the wafer W in the vapor supplying step. After the vapor supplying step, the spin drying process (Step S5) is performed to dry the wafer W as in the wafer treatment process shown in FIGS. 3(a), 3(b), 3(c) and 3(d).

FIG. 6 is a diagram for explaining further another wafer treatment process to be performed by the substrate treatment apparatus 1. With reference to FIGS. 1, 3(a), 3(b), 3(c), 3(d) and 6, a difference between the wafer treatment process shown in FIG. 6 and the wafer treatment process shown in FIGS. 3(a), 3(b), 3(c) and 3(d) will hereinafter be described.

A major difference between the wafer treatment process shown in FIG. 6 and the wafer treatment process shown in FIGS. 3(a), 3(b), 3(c) and 3(d) is that the rinsing process is performed by employing a DIW/IPA mixture as the first lower surface-tension liquid after the chemical agent is supplied as the treatment liquid, and then the IPA vapor is supplied as the vapor of the second lower surface-tension liquid.

In the wafer treatment process shown in FIG. 6, more specifically, the controller 47 opens the DIW valve 27 and the IPA valve 28 to supply the DIW and the IPA to the manifold 22 after the chemical treatment process (treatment liquid supplying step, Step S11) is performed on the front surface of the wafer W. After the supplied DIW and IPA are sufficiently mixed in the manifold 22 and the stirring-finned flow pipe 30, the resulting DIW/IPA mixture is supplied to the front surface of the wafer W from the second nozzle 4. That is, the DIW/IPA mixture is supplied as the first lower surface-tension liquid to the front surface of the wafer W (pre-drying liquid supplying step, Step S12). Thus, the chemical agent remaining on the front surface of the wafer W after the chemical treatment process is rinsed away to be replaced with the DIW/IPA mixture.

After the completion of the pre-drying liquid supplying step, the controller 47 controls the shield plate lift drive mechanism 45 to locate the substrate opposing surface 31 of the shield plate 5 in proximity to the front surface of the wafer W, and opens the second valve 41 to eject the IPA vapor as the vapor of the second lower surface-tension liquid from the opening 32 of the substrate opposing surface 31 (vapor supplying step, Step S13). The ejected IPA vapor is supplied to the entire front surface of the wafer W to be dissolved in a liquid mass remaining on the front surface of the wafer W. Since the liquid mass remaining on the front surface of the wafer W is the DIW/IPA mixture, the supplied IPA vapor is satisfactorily dissolved in the liquid mass. At the same time, the DIW contained in the liquid mass remaining on the front surface of the wafer W is evaporated from the surface of the liquid mass to be completely removed from the front surface of the wafer W.

The liquid mass remaining on the front surface of the wafer W after the pre-drying liquid supplying step is the DIW/IPA mixture, which has a lower surface tension than the deionized water. Therefore, the supply of the IPA vapor in the vapor supplying step makes it possible to dissolve the IPA in the liquid mass on the wafer W while suppressing the convection occurring in the liquid mass on the wafer due to the Marangoni effect. Since the DIW/IPA mixture to be supplied in the pre-drying liquid supplying step is sufficiently mixed, the DIW contained in the mixture can be efficiently removed from the front surface of the wafer W in the vapor supplying step. After the vapor supplying step, the spin drying process (Step S14) is performed to dry the wafer W as in the wafer treatment process shown in FIGS. 3(a), 3(b), 3(c) and 3(d).

FIG. 7 is a diagram for explaining still another exemplary wafer treatment process to be performed by the substrate treatment apparatus 1. With reference to FIGS. 1, 3(a), 3(b), 3(c), 3(d) and 7, a difference between the wafer treatment process shown in FIG. 7 and the wafer treatment process shown in FIGS. 3(a), 3(b), 3(c) and 3(d) will hereinafter be described.

A major difference between the wafer treatment process shown in FIG. 7 and the wafer treatment process shown in FIGS. 3(a), 3(b), 3(c) and 3(d) is that the IPA is employed as the treatment liquid (rinse liquid) and the HFE vapor is employed as the vapor of the second lower surface-tension liquid.

In the wafer treatment process shown in FIG. 7, more specifically, the controller 47 opens the IPA valve 28 to supply the IPA as the treatment liquid from the second nozzle 4 toward the rotation center of the front surface of the wafer W held by the spin chuck 2 (treatment liquid supplying step, Step S22) after the chemical treatment process is performed on the front surface of the wafer W (Step S21). The IPA supplied to the front surface of the wafer W instantaneously spreads over the entire front surface of the wafer W by the centrifugal force generated by the rotation of the wafer W. Thus, the chemical agent remaining on the front surface of the wafer W is rinsed away to be replaced with the IPA. That is, the rinsing process is performed to rinse the entire front surface of the wafer W with the IPA.

After the completion of the treatment liquid supplying step, the controller 47 closes the IPA valve 28 to stop the supply of the IPA from the second nozzle 4 and, at the same time, opens the HFE valve 29 to eject the HFE as the first lower surface-tension liquid from the second nozzle 4 toward the front surface of the wafer W (pre-drying liquid supplying step, Step S23). The ejected HE is supplied to the entire front surface of the water W. Thus, the IPA remaining on the front surface of the wafer W after the treatment liquid supplying step is mostly replaced with the HFE. Since the IPA is soluble in the HFE, the IPA still remaining on the front surface of the wafer W without the replacement with the HFE is dissolved in the HFE supplied to the front surface of the wafer W.

After the completion of the pre-drying liquid supplying step, the controller 47 controls the shield plate lift drive mechanism 45 to locate the substrate opposing surface 31 of the shield plate 5 in proximity to the front surface of the wafer W, and opens the third valve 42 to eject the HFE vapor as the vapor of the second lower surface-tension liquid from the opening 32 of the substrate opposing surface 31 (vapor supplying step, Step S24). The ejected HFE vapor is supplied to the entire front surface of the wafer W to be dissolved in a liquid mass remaining on the front surface of the wafer W. Since the liquid mass remaining on the front surface of the wafer W consists of the HFE and the IPA, the supplied HFE vapor is satisfactorily dissolved in the liquid mass. At the same time, the IPA contained in the liquid mass remaining on the front surface of the wafer W is evaporated from the surface of the liquid mass to be completely removed from the front surface of the wafer W.

The liquid mass remaining on the front surface of the wafer W after the pre-drying liquid supplying step is a mixture of the HFE and the IPA, which is different in surface tension from the HFE by not greater than the predetermined value. Therefore, the supply of the HFE vapor in the vapor supplying step makes it possible to dissolve the HFE in the liquid mass on the wafer W while suppressing the convection occurring in the liquid mass on the wafer W due to the Marangoni effect. Since the IPA still remaining on the front surface of the wafer W without the replacement with the HFE in the pre-drying liquid supplying step is already dissolved in the HFE, the IPA can be efficiently removed from the front surface of the wafer W in the vapor supplying step. After the vapor supplying step, the spin drying process (Step S25) is performed to dry the wafer W as in the wafer treatment process shown in FIGS. 3(a), 3(b), 3(c) and 3(d).

In the wafer treatment process shown in FIG. 7, the rinsing process is preformed by employing the IPA which is an organic solvent having a lower surface tension than the deionized water. Therefore, the drying of the wafer W may be achieved by performing the spin drying process after the rinsing process. This also makes it possible to dry the wafer W in a shorter period of time while suppressing the defects resulting from improper drying. Even with the use of an organic solvent such as the IPA having a lower surface tension, however, the collapse of the pattern and other damages are liable to occur due to the surface tension of the organic solvent depending on the type of the wafer W to be treated. Therefore, where such a wafer W is treated, the IPA present on the wafer W is preferably first replaced with the HFE having a lower surface tension than the IPA, and completely removed from the wafer W as in this embodiment. Thus, the pattern collapse attributable to the surface tension of the IPA can suppressed.

It should be understood that the present invention be not limited to the embodiments described above, but various modifications may be made within the purview of the claims. In the wafer treatment processes described above, the wafer W is dried by the spin drying process by way of example, hut the drying of the wafer W may be achieved by any other drying method.

For example, the wafer W may be dried in air. More specifically, the drying of the wafer W may be achieved by evaporating the liquid mass on the wafer W with the shield plate 5 significantly retracted above the spin chuck 2. Alternatively, the drying of the wafer W may be achieved by supplying the nitrogen gas to the front surface of the wafer W after the vapor supplying step. At this time, the wafer W may be rotated or not rotated.

In the embodiments described above, the vapor of the mixture of the liquid IPA and the liquid HFE is employed as the vapor of the second lower surface-tension liquid by way of example. Alternatively, vapor mixture of the IPA vapor and the HFE vapor may be employed.

In the embodiments described above, the vapor of the second lower surface-tension liquid is simply required to contain vapor of at least one lower surface-tension liquid. For example, a vapor mixture of the vapor of the lower surface-tension liquid and vapor of any other liquid may be employed. Specific examples of the vapor mixture include a vapor mixture of the HFE vapor and steam, a vapor mixture of the IPA vapor and steam, and vapor of a mixture of the liquid IPA and water.

In the embodiments described above, the substrate (wafer W) is generally horizontally held and rotated when being treated by supplying the treatment liquid to the front surface of the substrate, but may be treated in a non-rotative state by supplying the treatment liquid to the front surface of the substrate. The non-rotative state may be a stationary state in which the substrate is neither rotated nor moved, or a moving state in which the substrate is not rotated but is moved in a predetermined direction.

In the embodiments described above, the substrate to be treated is the wafer W, but is not limited to the wafer W. Examples of the substrate to be treated include any of various types of substrates including substrates for liquid crystal display devices, substrates for plasma display devices, substrates for FED devices, substrates for optical disks, substrates for magnetic disks, substrates for magneto-optical disks, substrates for photo masks and ceramic substrates.

While the present invention has been described in detail by way of the embodiments thereof, it should be understood that these embodiments are merely illustrative of the technical principles of the present invention but not limitative of the invention. The spirit and scope of the present invention are to be limited only by the appended claims.

This application corresponds to Japanese Patent Application No. 2007-31245 filed in the Japanese Patent Office on Feb. 9, 2007, the disclosure of which is incorporated herein by reference.

What is claimed is:

1. A substrate treatment method comprising:
a treatment liquid supplying step of supplying a treatment liquid to a major surface of a substrate;
a pre-drying liquid supplying step of supplying a first lower surface-tension liquid having a lower surface tension than deionized water to the major surface after the treatment liquid supplying step; and
a vapor supplying step of supplying vapor of a second lower surface-tension liquid having a lower surface tension than the deionized water and soluble in the first lower surface-tension liquid to the major surface after the pre-drying liquid supplying step.

2. The substrate treatment method according to claim 1, wherein the second lower surface-tension liquid to be supplied in a vapor form to the major surface of the substrate in the vapor supplying step is soluble in the treatment liquid.

3. The substrate treatment method according to claim 2, wherein the second lower surface-tension liquid to be supplied in the vapor form to the major surface of the substrate in the vapor supplying step is a liquid mixture containing a liquid soluble in the treatment liquid.

4. The substrate treatment method according to claim 1,
wherein the first lower surface-tension liquid to be supplied to the major surface of the substrate in the pre-drying liquid supplying step is lower in surface tension than the treatment liquid supplied to the major surface of the substrate in the treatment liquid supplying step,
wherein the second lower surface-tension liquid to be supplied in a vapor form to the major surface of the substrate in the vapor supplying step is lower in surface tension than the treatment liquid supplied to the major surface of the substrate in the treatment liquid supplying step.

5. The substrate treatment method according to claim 1, wherein a difference in surface tension between the second lower surface-tension liquid to be supplied in a vapor form to the major surface of the substrate in the vapor supplying step and the first lower surface-tension liquid is not greater than a predetermined value.

6. The substrate treatment method according to claim 1, further comprising a substrate rotating step of rotating the substrate, the substrate rotating step being performed in parallel to the pre-drying liquid supplying step and the vapor supplying step.

7. The substrate treatment method according to claim 1, wherein the vapor supplying step includes the step of keeping a substrate opposing surface of a substrate opposing member in opposed relation to the major surface of the substrate, and the step of supplying the vapor into a space defined between the substrate opposing surface and the major surface kept in opposed relation to each other.

8. The substrate treatment method according to claim 7, wherein the vapor supplying step includes the step of supplying the vapor into the space between the substrate opposing surface and the major surface with the substrate opposing surface being located in proximity to the major surface.

9. The substrate treatment method according to claim 7,
wherein the vapor supplying step includes the step of heating the substrate opposing surface and a flow pipe though which the vapor flows,
wherein the vapor of the second lower surface-tension liquid is supplied to the major surface with the substrate opposing surface and the flow pipe kept at a temperature higher than a condensation temperature of the vapor of the second lower surface-tension liquid in the vapor supplying step.

10. The substrate treatment method according to claim 1, wherein the vapor supplying step includes the step of supplying the vapor of the second lower surface-tension liquid to the major surface with the major surface kept at a temperature not higher than a temperature of the second lower surface-tension liquid at which a condensation partial vapor pressure of the second lower surface-tension liquid is equal to a saturation vapor pressure of the second lower surface-tension liquid.

11. The substrate treatment method according to claim 1, further comprising a substrate drying step of drying the substrate by removing a liquid mass adhering to the major surface of the substrate after the vapor supplying step.

12. The substrate treatment method according to claim 11, wherein the substrate drying step includes the step of drying the substrate by rotating the substrate.

13. The substrate treatment method according to claim 1, wherein the second lower surface-tension liquid to be supplied in a vapor form to the major surface of the substrate in the vapor supplying step is a liquid of the same type as the first lower surface-tension liquid.

14. The substrate treatment method according to claim 1, wherein the first lower surface-tension liquid to be supplied to the major surface of the substrate in the pre-drying liquid supplying step is a liquid mixture containing a liquid having a lower surface tension than the deionized water.

15. The substrate treatment method according to claim 14, wherein the pre-drying liquid supplying step includes the step of stirring the liquid mixture by a stirring unit.

16. A substrate treatment apparatus comprising:
a substrate holding unit arranged to hold a substrate;
a treatment liquid supplying unit arranged to supply a treatment liquid to a major surface of the substrate;
a pre-drying liquid supplying unit arranged to supply a first lower surface-tension liquid having a lower surface tension than deionized water to the major surface of the substrate;
a vapor supplying unit arranged to supply vapor of a second lower surface-tension liquid having a lower surface tension than the deionized water and soluble in the first lower surface-tension liquid to the major surface of the substrate;
a control unit arranged to control the substrate holding unit, the treatment liquid supplying unit, the pre-drying liquid supplying unit and the vapor supplying unit to perform a treatment liquid supplying step of supplying the treatment liquid from the treatment liquid supplying unit to the major surface of the substrate held by the substrate holding unit, a pre-drying liquid supplying step of supplying the first lower surface-tension liquid from the pre-drying liquid supplying unit to the major surface of the substrate held by the substrate holding unit after the treatment liquid supplying step, and a vapor supplying step of supplying the vapor of the second lower surface-tension liquid from the vapor supplying unit to the major surface of the substrate held by the substrate holding unit after the pre-drying liquid supplying step.
